(19) United States
(12) Patent Application Publication
(10) Pub. No.: US 2020/0318219 A1
(43) Pub. Date: Oct. 8, 2020

(54) Mechanochemical recovery of Co, Li and other constituents from spent lithium-ion batteries

(71) Applicant: Iowa State University Research Foundation, Inc., Ames, IA (US)

(72) Inventors: Oleksandr Dolotko, Ames, IA (US); Viktor Balema, Ames, IA (US); Ihor Hlova, Ames, IA (US); Shalabh Gupta, Ames, IA (US); Yaroslav Mudryk, Ames, IA (US); Vitalij K. Pecharsky, Ames, IA (US)

(21) Appl. No.: 16/873,071

(22) Filed: Jan. 28, 2020

Related U.S. Application Data
(60) Provisional application No. 62/919,933, filed on Apr. 4, 2019.

(51) Int. Cl. C22B 3/00; H01M 10/0525; H01M 10/54; C01D 15/02; C01D 15/08; C01D 15/04; C01G 51/08; C22B 7/00

(52) U.S. Cl. CPC C22B 23/043; H01M 10/0525; H01M 10/54; C01D 15/02; C01D 15/08; C01P 2006/42; C01G 51/085; C22B 7/007; C22B 7/005; C01P 2002/72; C01D 15/04

(57) ABSTRACT

Method embodiments useful for recycling spent lithium-ion battery (LIB) electrodes to extract critical and/or valuable elements from LIBs are provided and involve mechanochemical processing of spent LIB electrodes in the presence of certain chemical agents to recover products that can include, but are not limited to, metallic solids such as elemental metals or metal alloys, and/or inorganic compounds, metal salts, or organometallic derivatives. The desired products can be separated from by-products and contaminants and further processed into LIB electrode materials or/and other substances.

### RELATED APPLICATION

This application claims benefit and priority of U.S. provisional application Ser. No. 62/919,933 filed Apr. 4, 2019, the entire disclosure of which is incorporated herein by reference.

### CONTRACTUAL ORIGIN OF THE INVENTION

This invention was made with government support under Contract No. DE-AC02-07CH11358 awarded by the U.S. Department of Energy. The government has certain rights in the invention.

### FIELD OF THE INVENTION

The present invention relates recycling spent lithium-ion battery (LIB) electrode material(s) via mechanochemical processing to extract critical and/or valuable constituent elements of the LIB cathode.

### BACKGROUND OF THE INVENTION

Exponentially growing use of LIBs in portable electronics, vehicle propulsion and other energy storage and distribution applications has substantially increased the demand for constituent elements, namely Li, Co, Mn, and Ni, elevating them to the status of “critical elements” [reference 1]. In addition, spontaneous environmental degradation and leaching of Co from spent LIBs that end up in landfills or are improperly stored, poses significant environmental and health hazards [references 2-4]. At present, safe and economical recycling of used LIBs to recover Li, Co, Mn or Ni represents a considerable technological challenge [reference 5].

Several different approaches to recycling of LIBs have been proposed to date. They include hydrometallurgical [references 6-11], biohydrometallurgical [references 12-14] and pyrometallurgical [references 15-17] methods.

The common steps for the majority of these recycling processes comprise of:

1—Physical processing, which involves discharge, disassembly, and electrode separation;

2—Mechanical processing by shredding, crushing, grinding and sieving;

3—Chemical conversion, by smelting, leaching or dissolution;

4—Separation and purification by precipitation, recrystallization, electrolysis and other appropriate chemical techniques.

Some pyrometallurgical methods bypass the mechanical processing step (i.e., step 2 above) and use high temperature smelting to prepare multi-metal alloys, comprising (Co, Mn, Ni, Fe, Al)-containing slags. The loss of valuable components such as Li and carbon/graphite, which are emitted as hazardous gases, and high energy consumption are among the main disadvantages of the pyrometallurgical methods [references 15-17].

While more efficient and less hazardous than pyrometallurgy, biohydrometallurgical approach suffers from long processing times, often extending over more than 5-10 days for complete extraction from a single batch, and also presents challenges associated with bacterial incubation (acidity and temperature control required) [references 12-14].

Hydrometallurgical processes involve chemical dissolution of spent LIB electrodes by strong acids or bases [references 6-11], are relatively energy efficient and usually generate limited amounts of hazardous gases. They offer high metal recovery rates and good purity of recovered materials. However, they utilize highly corrosive leachants. Coupled with high cost of battery disassembly and separation of electrode materials, industrial use of hydrometallurgical processes is limited.

In-situ studies of fatigue in commercial 18650-type cells have revealed that loss of the active Li in both cathode and anode as well as microstructural changes in the electrodes are responsible for the battery degradation. The studies also showed that the active battery component of the battery cathode, LiCoO₂ also retains its chemical nature in the spent LIB cathodes. See O. Dolotko et al., Fatigue process in Li-ion Cells: An in-situ combined neutron diffraction and electrochemical study, J. Electrochem. Soc. 159, A2082-A2088, 2012.

### SUMMARY OF THE INVENTION

The present invention provides method embodiments useful for recycling spent lithium-ion battery (LIB) electrode material to extract critical and/or valuable elements from LIB electrode material. Illustrative method embodiments involve mechanochemical processing of spent LIB electrode material to recover products that can include, but are not limited to, metallic solids such as elemental metals or metal alloys, inorganic compounds, metal salts, and/or organometallic derivatives. The desired products can be separated from by-products and contaminants and further processed into LIB electrode materials or/and other substances. The recovered elements can be used for manufacturing of new LIB electrodes or in other applications.

A particular illustrative method embodiment involves mechanochemical conversion of LIB electrode material by their mechanical processing in the presence of one or more chemical reducing agents in the absence of a solvent wherein the chemical reducing agent can include, but is not limited to, an active metal reductant such as at least one of Li, Na, K, Mg, Ca, Sr, Ba, Al, Zn, rare earth metal, mischmetal, and any combination thereof as well as alloys thereof. Magnetic reaction products, such as a metal or metal alloy of Co, Ni, Mn, etc., can be separated using magnetic separating techniques.

Another particular illustrative method embodiment involves mechanochemical conversion of LIB electrode material by their mechanical processing in the presence of one or more reactive functionalized organic materials that are effective to form water-soluble products, especially water-soluble metal salts such as Li salts, Co salts and/or other metal salts, from the LIB electrode material. The water-soluble salts can be further chemically treated such as by using aqueous, acidic or basic leaching to recover the critical and/or valuable elements separated from insoluble by-products.

Practice of embodiments of the present invention provides advantages that include, but are not limited to:
1. Ambient processing temperature can be used.
2. Commercial scalability of the mechanochemical processing to increase efficiency at large scale.
3. Provides high conversion (recovery) rates of desired critical LIB constituents.
4. Uses low cost chemical agents such as commercially available foil, scrap of Al, functionalized polymers or other organic compounds can be used.
5. Provides liquid-free initial separation of Co and Ni components using magnetic force.
6. Reduces generation of liquid waste streams to foster environmental sustainability.

These and other advantages of practice of embodiments of the present invention will become more apparent from the following detailed description taken with following drawings.

### BRIEF DESCRIPTION OF THE DRAWINGS

FIG. 1 shows XRD powder patterns of samples from LiCoO₂—Al system: XRD pattern (a)—ball milled sample from step 1.1; XRD pattern (b)—sample representing solid magnetic fraction after the magnetic separation (step 1.3); XRD pattern (c)—Co recovered and recrystallized after step 1.4; XRD pattern (d)—Li₂CO₃ recovered after step 1.5.

FIG. 2 shows XRD powder patterns of LiCoO₂—Li reduction products: XRD pattern (a)—ball milled sample from step 2.1; XRD pattern (b)—after dissolution and magnetic separation (step 2.3); XRD pattern (c)—Li₂CO₃ recovered after step 2.4.

FIG. 3 shows XRD powder patterns of LiCoO₂—Ca reaction products: XRD pattern (a)—ball milled sample from step 3.1; XRD pattern (b)—after dissolution and magnetic separation (step 3.3).

FIG. 4 is an illustration of battery disassembly and the powder obtained after pre-milling of the Li-ion cell components (cathode, anode and separator).

FIG. 5 illustrates the process of mechanochemical/chemical recovery of Li and Co from the Li-ion cell components.

FIG. 6 shows XRD powder patterns of products recovered mechanochemically from LCO 18650-type cell: XRD pattern (a)—cell components ball milled with Al for 1 hour; XRD pattern (b)—material from step 4.3 after the magnetic separation; XRD pattern (c)—Li₂CO₃ recovered in step 4.4 (LiAl₂(OH)₇.xH₂O Bragg peaks marked with asterisks).

### DETAILED DESCRIPTION OF THE INVENTION

Certain embodiments of the present invention are described and useful for recycling spent lithium-ion battery (LIB) electrode material to extract critical and/or valuable elements from LIB cathodes. Illustrative embodiments of the present invention employ mechanochemical processing wherein the mechanical processing can include, but is not limited to, ball milling, shredding, grinding, and/or extruding and combinations thereof, which can be used for processing LIB electrode materials. The mechanical processing is conducted in the presence of one or more chemical agents selected to promote progression of chemical transformations of LIB electrode constituents during mechanical processing.

In one illustrative embodiment, an active metal reductant, such as at least one of Li, Na, K, Mg, Ca, Sr, Ba, Al, Zn, rare earth metal and mischmetal, any combination thereof, and/or an alloy made from these active metals, is employed as a reducing agent during mechanical processing to form reduced metal or metal alloy products, such as metal or alloys of Co, Ni. Mn and others. Ferromagnetic products of such mechano-chemical processing can be separated from other by-products by magnetic separation processes.

Exemplary of such mechanochemical processing embodiment converts Li,Co-based oxide electrode materials into a mixture of products containing metallic cobalt (reduced to Co⁰) or metallic alloys based on the metallic cobalt and water-soluble lithium-containing salts. The cobalt or cobalt-based metallic alloys can be further recovered from the reaction mixtures using magnetic separation and processed into desired products by conventional means. Water-soluble lithium-containing salts can be recovered and processed using conventional chemical protocols.

In another illustrative embodiment, a reactive functionalized organic chemical material is employed during mechanical processing to transform certain LIB constituents to water-soluble products, especially water-soluble metal salts such as Co salts, Li salts and/or other metal salts, from the LIB cathodes. The reactive functionalized organic material can comprises a polymer or co-polymer functionalized with a halogen such as including, but not limited to, at least one of a polyvinylidene halide, a halogenated polyethylene, a halogenated polystyrene, and halogenated co-polymer and a reactive-functionalized small organic molecule such as halogenated carboxylic acid or other molecule. The water-soluble salts can be further chemically treated to recover the critical and/or valuable elements separated from insoluble by-products.

Exemplary of such a mechanochemical process embodiment converts Li,Co-based oxide electrode materials into a mixture of products containing water-soluble metal salts such as cobalt dichloride (CoCl₂) and lithium chloride (LiCl). The water-soluble metal salts can be recovered and processed using aqueous chemistry, such as aqueous acidic or basic leaching processing.

The following examples are offered to further illustrate but not limit embodiments of the present invention:

These examples describe recovery of cobalt (Co), cobalt alloyed with other transition metals, and lithium (Li) from both the pure LiCoO₂, which is among the most common cathode materials used for LIBs, and actual LIB electrodes. Although the chemical transformations that accompany the process according to an embodiment of the invention are illustrated below on the basis of the mechanochemical reduction of pure LiCoO₂ to elemental Co and Li₂O using elemental Al, Ca and Li, other alkali and alkaline-earth metals, as well as other active metals that reduce Co³⁺ to Co⁰, such as Zn, pure rare earth metals (that can include one or more of the fifteen lanthanides, Sc, and Y), or mischmetal, can be effective in practice of embodiments of the invention.

All of the reactions described below are applicable to any oxide LIB electrode material, whereas Co can be replaced with (Co₁₋ₓMₓ), wherein M represents one or more transition elements other than Co, for example Ni and Mn, that are present in the electrode material, and 0<x<1.

The reaction of LiCoO₂ with Al can be described as:

2LiCoO₂+2Al=Li₂O+2Co+Al₂O₃ (R1a)

Metallic Co formed in R1a can be easily separated from the non-magnetic by-products via a magnetic separation process and used as is or further purified if appropriate and required. Another reaction product, Li₂O, is soluble in water, where it forms LiOH (R1b) that can be precipitated out as insoluble lithium carbonate (Li₂CO₃) using 1.0 mol·L⁻¹ solution of sodium carbonate (R1c).

Li₂O+H₂O=2LiOH (R1b)

2LiOH+Na₂CO₃=Li₂CO₃↓+2NaOH (R1c)

The transformation of LiOH into Li₂CO₃ can be performed without adding the sodium carbonate, by using carbon dioxide CO₂, reaction Rid:

2LiOH+CO₂=Li₂CO₃↓+H₂O (R1d)

In an illustrative real-life scenario, Al foil is already present as a current collector in LIB cathodes which foil should reduce the amount of additional Al required for the reduction in R1a. In addition, Al can be used in R1a in the form of powder and/or as shredded Al scrap. It is worth noting that other possible battery materials such as copper, graphite or PVDF (Polyvinylidene fluoride) do not interfere with the mechanochemical reduction of LiCoO₂ by Al.

The process described in Eqs. R1a-d proceeds in a similar fashion when Al is replaced by Ca or Li as the reducing agent. This demonstrates versatility of practice of the invention embodiments with regards to the wide variety of reducing agents that may be employed.

2LiCoO₂+3Ca=Li₂O+2Co+3CaO (R2a)

Li₂O+3CaO+4H₂SO₄=3CaSO₄↓+Li₂SO₄+4H₂O (R2b)

Li₂SO₄+Na₂CO₃=Na₂SO₄+Li₂CO₃↓ (R2c)

LiCoO₂+3Li=2Li₂O+Co (R3a)

When Li or Ca is used as a reducing agent, both Li₂O and CaO (unlike Al₂O₃) formed during the reaction can be dissolved in water to form lithium and calcium hydroxides, LiOH and Ca(OH)₂, respectively. Subsequently, Ca can be recovered as insoluble calcium sulfate (CaSO₄) using sulfuric acid (H₂SO₄) and Li can be isolated as insoluble Li₂CO₃ (R2b and R2c).

The feasibility of the processes described in reactions R1-R3 was experimentally demonstrated as follows. Mixtures of LiCoO₂ and the reducing metal (˜2 g total) taken in the required molar ratios (R1a, R2a, R3a) were ball milled in an 8000M SPEX mill. The mechanochemical reaction with Al as a reducing element was performed in the air atmosphere, and formation of the reduction products was observed after 1 hour of milling in a 50 ml hardened-steel vial with 20 g of steel balls (two large balls weighing 8 g each and four small balls weighing 1 g each).

When air sensitive reducing elements, like Li or Ca, are used, the mechanochemical treatments should be performed in an inert oxygen- and water-free atmosphere. Because the cobalt material obtained in the mechanochemical reaction R1a was semi-amorphous, annealing was carried out in a quartz tube in vacuum at 900° C. for 36 hours before X-ray powder diffraction (XRD) experiments. The annealing was performed to confirm the presence of Co⁰ in the mixture. However, for additional purification or utilization of the obtained semi-amorphous cobalt metal such annealing is not necessary and can be skipped, as X-ray amorphous Co remains ferromagnetic at room temperature. The XRD characterization was carried at room temperature using a PANalytical powder diffractometer utilizing Cu-Kα₁ radiation with a 0.02° 2θ step in the range of Bragg angles 2θ from 10° to 80°.

The practical application of the method embodiments of the invention was demonstrated using the constituents of disassembled commercial 18650-type rechargeable Li-ion LCO/NMC cells (mixed LiCoO₂/Li(CoNiMn)O₂ cathode, graphite anode). All battery constituents e.g. cathode and anode on their Al and Cu current collectors along with separator were removed from the cell and mechanochemically processed by ball milling in air atmosphere in the presence of reducing element Al in a form of a foil (the total mass of the mixture was 2 g). The ball milling was performed in 8000M SPEX mill using the 50 ml hardened-steel vial with 20 g of steel balls (two large balls weighing 8 g each and four small balls weighing 1 g each). The presence of polymeric materials (separator and binder) decreases the kinetics of the reduction reaction, hence the ball milling time necessary to fully complete the reaction must be increased. The magnetic phase already formed after 1 hour of milling; however, the starting materials were still present. After 8 hours of milling the reduction reaction was completed.

### Example 1. Recovery of Co and Li from LiCoO₂ Using Al as Reducing Element

LiCoO₂ (97 wt. %) and Al −325 mesh powder (99.5 wt. %) were used as received from Alfa Aesar.

Step 1.1. Mechanochemical Reaction

Starting materials LiCoO₂ and Al powder (˜2 g of mixture) taken in a 1:1 molar ratio were ball milled in the 8000M SPEX mill for 1 hour in the 50 ml hardened-steel vial with 20 g of steel balls (two large balls weighing 8 g each and four small balls weighing 1 g each). The loading of the sample into a vial and removal of the product were performed in air.

Step 1.2. Dissolution and Magnetic Separation

The material obtained in step 1.1 was mixed with 200 ml of deionized water in a 300 ml beaker (B1) and stirred for 1 minute at 1000 rpm. The resulting mixture contained an insoluble-in-water precipitate and a solution. To separate the magnetic part of the precipitate from the rest of the product, a permanent magnet was placed to the side of a beaker. Proximity of the magnet attracts the magnetic particles to the side of the beaker, while the rest of the non-magnetic solid product remains at the bottom. More effective separation was achieved when the mixture was agitated by a spatula before the magnet was brought near the beaker. The non-magnetic product and the solution were removed into a 1000 ml beaker (B2) for use in step 1.5, while the magnetic phase, attracted by magnet to the side of the beaker remains in B1.

A 200 ml of deionized water was added to B1 with the magnetic phase and mixed by a spatula for 30 seconds. The magnetic phase was again separated by a permanent magnet. All of the remaining non-magnetic precipitate and the solution from B1 were moved to B2. Such procedure of washing away the nonmagnetic products was repeated 4 times. During the last washing and magnetic separation, the solution in B1 is transparent, and all solid fraction stays attracted to the wall of B1 by the magnet.

Step 1.3. Cobalt Extraction

To ensure no Li₂O or other non-magnetic products mixed with cobalt remain, the magnetic phase was further washed with a diluted to 3% hydrochloric acid (HCl). 100 ml of the acid was mixed with the magnetic phase and stirred for 1 minute at 500 rpm. After that, the magnetic separation was performed again. The magnetic Co phase was washed 5 times with 200 ml of deionized water. The magnetically separated cobalt was placed into an oven and dried at 90° C. in air for 3 hours.

The Co recovery rate of ˜90% was calculated based on the weight of the ball milled mixture and the obtained magnetic product.

Step 1.4. Cobalt Recrystallization

The dry product after washing and magnetic separation, obtained is step 1.3 was sealed into a quartz tube in vacuum and heated to 900° C. to recrystallize Co. The sample was kept at this temperature for 36 hours and then cooled down. This step is unnecessary for the recovery of Co and was performed only to ensure definitive detection by powder X-ray diffraction.

Step 1.5. Lithium Extraction

The LiOH solution from B2, obtained in step 1.2 was filtered to remove the Al₂O₃ precipitate. The water was partially evaporated from the filtrate solution in B2. As a result, 200 ml of LiOH solution was retained in a beaker 3 (B3). Further, 300 ml of 1.0 mol·L⁻¹ solution of Na₂CO₃ was added to the solution of LiOH and agitated for 1 h at 500 rpm. Li₂CO₃ precipitate was filtered and dried at 90° C. in air. A total of ˜70% of the Li present in the starting mixture employed in step 1.1 was recovered as solid Li₂CO₃.

Step 1.6. Materials Characterization

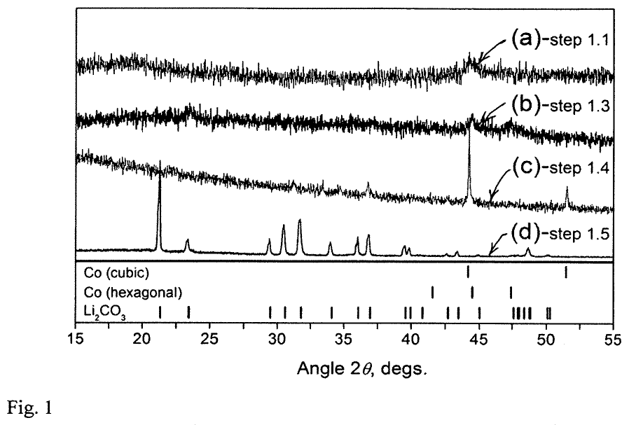

The magnetic solid fraction was analyzed by powder X-ray diffraction (XRD) as obtained in step 1.3 and after it was recrystallized in step 1.4. Before the recrystallization, the nearly X-ray amorphous metal powder contains both face-centered cubic and primitive hexagonal close-packed structures (FIG. 1a, 1b); Bragg peak positions correspond to those of metallic cobalt. After the recrystallization, only the cubic structure of Co is detected in the XRD pattern (FIG. 1c).

The XRD pattern of Li₂CO₃ after its precipitation from the LiOH solution (step 1.5) is shown in FIG. 1d.

### Example 2. Recovery of Co and Li from LiCoO₂ Using Li as Reducing Element

LiCoO₂ (97 wt. %) and Li (99 wt. %) were used as received from Alfa Aesar and Sigma-Aldrich respectively.

Step 2.1. Mechanochemical Reaction.

Starting materials LiCoO₂ and Li granules (˜2 g of mixture) taken in a 1:3 molar ratio were ball milled in the 8000M SPEX mill for 12 hours in a 50 ml silicon nitride (Si₃N₄) vial using three Si₃N₄ balls weighing 3.5 g each for 12 hours. The loading of the sample into the vial was performed in an Ar filled glove box. The ball milling was performed in a mill located in a nitrogen filled glove box. After the milling was complete, the sample was removed from the vial in air for further treatment.

Step 2.2. Dissolution and Magnetic Separation

The sample obtained after ball milling in step 2.1 was suspended in 200 ml of deionized water in a 300 ml beaker (B1) and stirred using a spatula for 10 seconds. As an important step, the initial dissolution of non-magnetic products in water must be performed quickly in order to avoid reaction of fine particles of elemental Co with highly basic LiOH formed by hydrolysis of Li₂O in water. The resulting bath contained an insoluble precipitate and a mixture of water-soluble products as a dirty solution. To separate magnetic solids from the rest of the product, a permanent magnet was placed to the side of a beaker. Proximity of the magnet attracts the magnetic product to the side of the beaker, while other non-magnetic solid products remain at the bottom. A more effective separation was achieved when the solution was agitated using a spatula before the magnet was brought near the beaker. The non-magnetic product and the solution were transferred into a 1000 ml beaker (B2) for further treatment, while the magnetic phase was left in beaker B1 for further washing and drying.

About 200 ml of deionized water was added to B1 containing the magnetic phase and stirred using a spatula for about 30 seconds. The suspension was subjected again to a magnetic field to selectively attract the magnetic solids to the wall of B1. All of the remaining non-magnetic precipitate and the solution from B1 were transferred to B2. This procedure of washing out the non-magnetic products was repeated 4 times. During the last washing and magnetic extraction, the solution in B1 is transparent and all solid fraction stays attracted by the magnet to the wall of the container.

Step 2.3. Cobalt Extraction

To ensure that no Li₂O or other non-magnetic products remained mixed with cobalt, the magnetic phase obtained in step 2.2 was further washed with a 3% hydrochloric acid (HCl) solution. Approximately 100 ml of the acid solution was added to the magnetic solid and stirred using magnetic stirrer for 1 minute at 500 rpm after which, magnetic separation was performed again. The magnetic solid was washed 5 times with 200 ml of deionized water. Finally, the magnetically separated solid (primarily containing cobalt) was placed in an oven and dried at 90° C. in air for 3 hours. Approximately 90 wt. % of the Co present in the starting material (step 2.1) was recovered as the result.

Step 2.4. Lithium Extraction

The solution from beaker B2 (primarily containing LiOH) obtained in step 2.2 was filtered to remove any insoluble precipitate, which have formed from some impurities present in the starting materials, oxides or other insoluble salts formed during steps 2.1 and 2.2. The water from the filtrate was allowed to evaporate partially, and, nearly 200 ml of the solution was retained in a separate beaker (B3). Then, 300 ml of 1.0 mol·L⁻¹ solution of Na₂CO₃ was added to the solution and stirred for 1 h at 500 rpm. A white precipitate was filtered and dried at 90° C. in air. According to X-ray diffraction analysis, Li₂CO₃ is present as a pure phase in the precipitate. The quantity of recovered Li₂CO₃ amounts to ˜70 wt. % recovery of Li from the starting material used in step 2.1.

Step 2.5. Materials Characterization

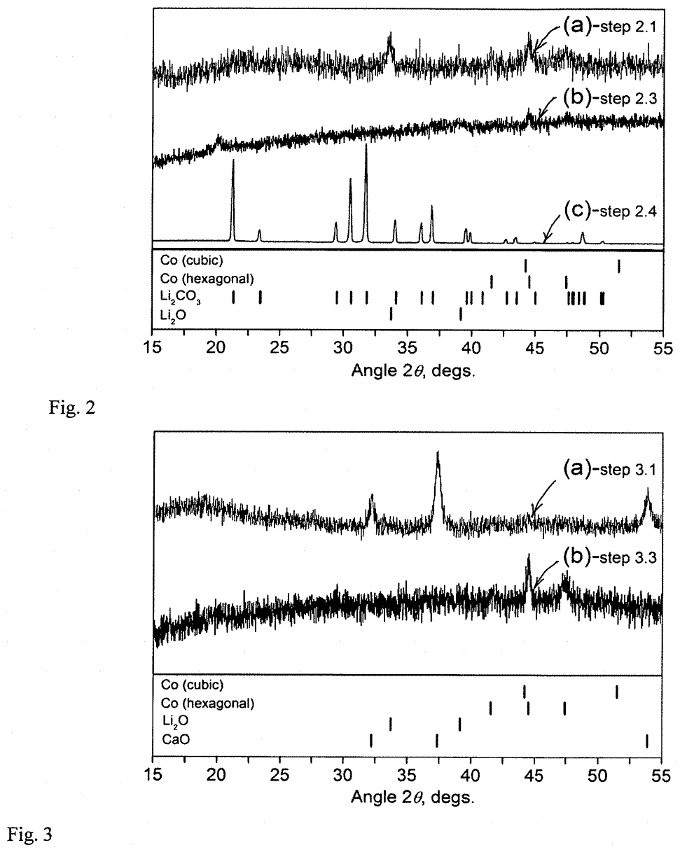

After the extraction and drying, the magnetic fraction obtained in step 2.3 was analyzed by powder X-ray diffraction. The X-ray pattern showed a poorly crystalline but clearly identifiable elemental cobalt present as the primitive hexagonal close-packed structure (FIG. 2a, b).

The XRD pattern of Li₂CO₃ after its precipitation from LiOH obtained in step 2.4 is shown on FIG. 2c.

### Example 3. Recovery of Co and Li from LiCoO₂ Using Ca as Reducing Element

LiCoO₂ (97 wt. %) and Ca (99.5 wt. %) were used as received from Alfa Aesar.

Step 3.1. Mechanochemical Reaction.

Starting materials LiCoO₂ powder and Ca pieces (˜2 g of mixture) taken in a 2:3 molar ratio were ball milled in the 8000M SPEX mill for 12 hours in a 50 ml Si₃N₄ vial using three Si₃N₄ balls weighing 3.5 g each. The loading of the sample into the vial was performed in an Ar filled glove box. After the ball milling the sample was removed from the vial in air for further treatment.

Step 3.2. Dissolution and Magnetic Separation

The material obtained after the ball milling in step 3.1 was suspended in 200 ml of deionized water in a 300 ml beaker (B1) and stirred for 10 seconds. The initial dissolution of non-magnetic products in water must be performed quickly to avoid the reaction of fine Co particles with LiOH and Ca(OH)₂ bases formed by the hydrolysis of Li₂O and CaO that formed mechanochemically. The resulting liquid bath contained an insoluble solid that precipitates out and a dirty solution. To separate any magnetic solid still suspended in the liquid, a permanent magnet was placed in close proximity to the side wall of the beaker. The magnet attracts all magnetic components in the product to the side of the beaker, while the rest of the non-magnetic solid product settles to the bottom. A more effective separation was achieved when the mixture was agitated or stirred before the magnet was brought near the beaker. The non-magnetic product(s) and the solution were transferred into a 1000 ml beaker (B2) for further treatment, while the magnetic components were left out in the beaker B1 for further washing and drying as below.

A 200 ml of deionized water was added to B1 with the magnetic phase and stirred for 30 seconds. The magnetic phase was again separated by a permanent magnet as described above. All of the remaining non-magnetic precipitate (containing possible impurities from starting materials, oxides or other insoluble salts formed in step 3.1) and the solution from B1 were transferred to B2. This procedure of washing away the non-magnetic products was repeated 4 times until the solution in B1 was transparent and the solid fraction stays attracted to the wall of B1 by the magnet.

Step 3.3. Cobalt Extraction

To ensure that no Li₂O, CaO or other non-magnetic products remain mixed with cobalt, the magnetic phase after step 3.2 was further washed with 100 ml of 3% hydrochloric acid (HCl). The acid was added to the solid magnetic phase and stirred for 1 minute at 500 rpm, followed by separation with a magnet as before. The magnetic phase was washed 5 times with 200 ml of deionized water. The magnetically separated cobalt was placed in an oven and dried at 90° C. in air for 3 hours. Overall, ˜90 wt. % of the Co present in the mixture used in step 3.1 was recovered.

Step 3.4. Lithium Extraction

The solution from B2 (˜1000 ml), obtained during the washing of the magnetic phase in step 3.2 was boiled to evaporate water and concentrate the solution. As a result, about 300 ml of solution of mixed LiOH and Ca(OH)₂ was obtained. Then, 200 ml of 1M sulfuric acid (H₂SO₄) was added to the solution and stirred for 1 h at 500 rpm at room temperature. As a result CaSO₄ precipitated, which was then filtered out. The water-soluble Li₂SO₄ obtained in the filtrate was recrystallized using a rotary evaporator. Approximately ˜70 wt. % of Li available in the initial mixture used in step 3.1 was recovered.

Step 3.5. Materials Characterization

The obtained samples after milling and dissolution with magnetic separation were analyzed using powder XRD. The XRD pattern of as-ball milled sample, obtained in step 3.1 contains strong Bragg reflections corresponding to CaO. The Co and Li₂O reflections are basically undetectable due to the X-ray amorphous states of these components. The XRD pattern of the sample obtained after dissolution and magnetic separation in step 3.3 clearly shows Bragg reflections from the elemental Co with the hexagonal close-packed structure (FIGS. 3a-3b).

### Example 4. Recovery of Co and Li from Commercial Li-Ion Cell Using Al as Reducing Element

Battery constituents (cathode, anode, and separator) were removed from a commercial 18650-type Li-ion cell, which contains mixed LiCoO₂/Li(CoNiMn)O₂ cathode on an Al current collector and graphite anode on a Cu current collector. The separator is a polymer (commonly polyethylene or/and polypropylene, or/and polyolefine). The binder which is commonly PVDF (Polyvinylidene fluoride) homoplymer, used commercially for binding the electrodes to current collectors is also present in the reaction system. Commercially available aluminum foil (heavy duty Reynolds Wrap aluminum foil) was used as a source of Al for the reduction reaction.

Step 4.1. Mechanochemical Reaction

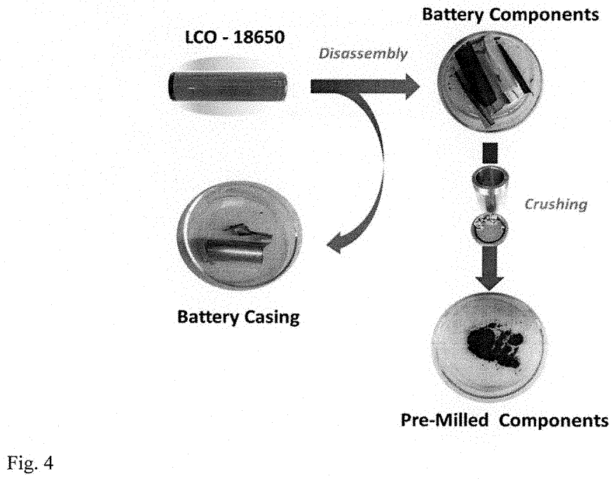

A total of ˜4 g of the battery constituents (pieces of cathode and anode together with the separator) were initially ball milled in the 8000M SPEX mill for 15 minutes in the 50 ml hardened-steel vial with 20 g of steel balls (two large balls weighing 8 g each and four small balls weighing 1 g each). The loading of the sample into the vial and the removal of the product were performed in air. After the milling, the product is powder as illustrated in FIG. 4.

Then, 1.5 g of this powder was loaded into the same steel vial and 0.5 g of aluminum foil was added to the mixture to make ˜2 g of the mixture total. The magnetic phase forms already after 1 hour of milling, however, the starting materials (LiCoO₂ and Al) are still present. Since both the separator and the binder are present in the reaction mixture, and because the active cathode material (LiCoO₂) is covered with the binder, presence of these polymers both temporarily protects LiCoO₂ and reduces the area of its contact with Al. As a result, the kinetics of the mechanochemical reduction is also reduced, when compared to examples 1, 2, and 3. Thus, the ball milling time necessary to fully complete the mechanochemical reduction must be increased compared to the reduction of the pure LiCoO₂. After 8 hours of milling the reduction reaction is completed. To improve kinetics or reduction reaction, the milling in the presence of a liquid assistant agent (LAA) can be utilized. With the proper selection of the LAA, the polymer binder, which is the main cause of the slower kinetics, can be dissolved, thus LiCoO₂ will react with Al faster.

Step 4.2. Dissolution and Magnetic Separation

The sample obtained after 8 h of ball milling in step 4.1 was mixed with 200 ml of deionized water in a 300 ml beaker (B1) and stirred for 1 minute at 1000 rpm. The resulting mixture contained an insoluble in water precipitate and a solution. To separate the magnetic part of the precipitate from the rest of the solids, a permanent magnet was placed to the side of a beaker. Proximity of the magnet attracts the magnetic product to the side of the beaker, while the rest of the non-magnetic solid product remains suspended in the solution and/or settles at the bottom of the beaker. A more effective separation was achieved when the mixture was agitated by a spatula before the magnet was brought near the beaker. The non-magnetic product and the solution were removed into a 1000 ml beaker (B2) for its further treatment, while the magnetic phase, attracted by the magnet to the side of the beaker remains in B1.

A 200 ml of deionized water was added to B1 with magnetic phase and stirred by a spatula for 30 seconds. The magnetic phase was again separated by a permanent magnet. All of the remaining non-magnetic precipitate and the solution from B1 were moved to B2. Such procedure of washing away the nonmagnetic products was repeated 4 times.

Step 4.3. Magnetic Phase Recovery

The magnetically separated material from step 4.2 was placed into a furnace and dried at 90° C. in air for 3 hours. The recovery was ˜0.1 g of the magnetic phase from 1 g of the pre-milled cell components.

Step 4.4. Lithium Recovery

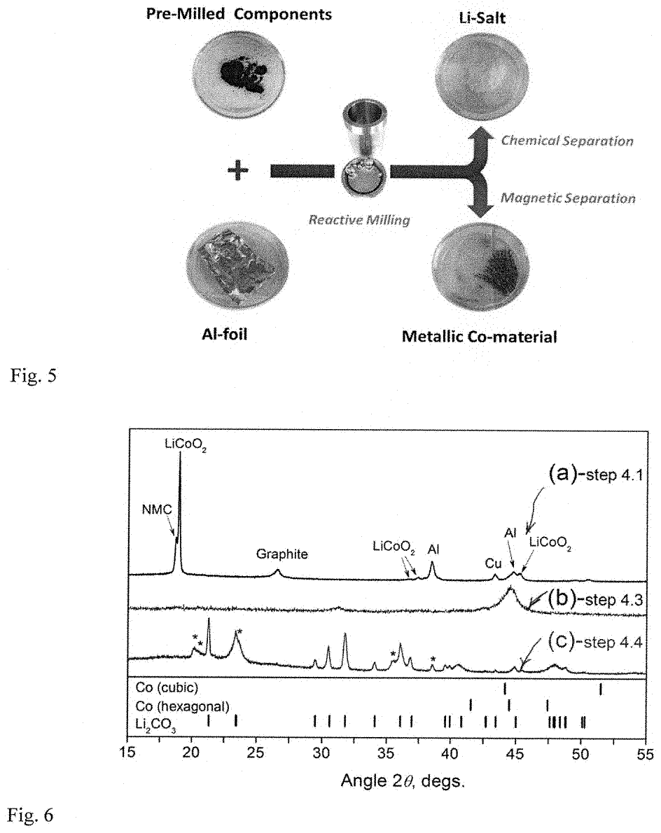

The aqueous solution from B2 obtained in step 4.2 was filtered to remove the graphite, Cu, remaining unreacted Al, polymers and Al₂O₃ precipitate. Next, water was evaporated and the residue was dried in air at room temperature, whereby LiOH reacted with CO₂ that is present in the ambient atmosphere to form Li₂CO₃. The rate of recovery was ˜0.07 g of Li₂CO₃ from 1 g of the pre-milled cell components. Steps 4.1, 4.2, 4.3, and 4.4 are further illustrated in FIG. 5.

Step 4.5. Materials Characterization

The powder after 1 hour milling and the magnetic phase obtained in step 4.3 were analyzed by powder X-ray diffraction (XRD) analysis. The powder XRD pattern of the sample milled for 1 hour indicates that all of the original battery components (LiCoO₂/NMC-cathode, Al-cathode current collector, Graphite-anode, Cu-anode current collector) are still present after the milling (FIG. 6a); they can no longer be detected after the milling for 8 hours. After the magnetic separation of the sample milled for 8 hours, a poorly crystalline phase with the structure corresponding to the face-centered cubic cobalt is the main phase of the metallic magnetic residue obtained in step 4.3 (FIG. 6b). Weak but noticeable shift of the Bragg reflection observed around 45° and diminished intensity of the Bragg reflection at about 52° are associated with mechanical alloying of minor quantities of other metals with the cobalt metal, i.e. Ni and Mn from the NMC component of the cathode, or/and Cu from the anode current collector, all of which were present in the pre-milled components.

The XRD pattern of Li₂CO₃ after its isolation in step 4.4 is shown in FIG. 6c. Minor impurities of Lithium Aluminium Hydroxide Hydrate (LiAl₂(OH)₇.xH₂O (Bragg peaks marked with asterisks), present in the material can be removed by an additional recrystallization.

### Example 4A. Recovery of Co and Li from Commercial Li-Ion Cathode Using Al as Reducing Agent

A commercial LIB cathode that consists of an Al current collector, a LiCoO₂ working material and a PVDF as a binder was cut in pieces. Then, 4 g of this material were combined with 0.5 g of an Al foil, and 20 g of steel balls (two large balls weighing 8 g each and four small balls weighing 1 g each) in a 50 ml hardened-steel milling vial. The vial was sealed under argon and the mixture was ball milled in a SPEX 8000 shaker mill for 2 and 3 hours.

Because Al was already present in the LIB cathode, the amount of the Al foil used in this experiment was reduced from the amounts used in other Examples. Furthermore, since the PVDF binder present in the electrode material could impede the reaction of LiCoO₂ with Al, a prolonged ball milling may be required to complete the reactions this case.

The formation of metallic Co became detectable after 2 hours of the processing. SEM EDS analysis confirmed the presence of the metallic Co in the sample after 2 hours of milling, which also agreed with the results of the XRD analysis. Small amounts of Mn and Ni were also detected in the material. Apparently, they were present in the original commercial cathode. Minor amounts of Al, 0, and C that perhaps originate from the reducing agent and the binder were also detected. The transformation of LiCoO₂ into the metallic Co and other reaction products was complete after 3 hours of milling.

The powder formed after 3 hours of milling was quenched with small amount of methanol under argon in a glove box, then treated with deionized (DI) water and stirred for a few minutes in air. The magnetic phase was removed from the slurry formed using a permanent magnet. The remaining slurry was set aside for the further processing.

Next, the magnetic fraction was dispersed in DI water and the magnetic separation step was repeated. The magnetic material obtained after magnetic separation (fcc Co metal) was sonicated in water for 5 minutes.

The recycling of 4 g of the cathode material produced 0.6 g of metallic Co. In addition, 0.3 g of Li₂CO₃ was recovered using experimental protocol described in Example 5. The weight ratio of Co to Li₂CO₃ was close to 2:1, which agrees with the numbers obtained for processing of pure LiCoO₂ described in Example 1.

### Example 5. Recovery of Co and Li from Commercial Li-Ion Cell Using Functionalized Organic Material

Battery constituents (cathode, anode, and separator) can be removed from a commercial 18650-type Li-ion cell, which contains mixed LiCoO₂/Li(CoNiMn)O₂ cathode on an Al current collector and graphite anode on a Cu current collector. The separator is a polymer (commonly polyethylene or/and polypropylene, or/and polyolefine). The binder which is commonly PVDF (Polyvinylidene fluoride) homoplymer, used commercially for binding the electrodes to current collectors is also present in the reaction system.

Step 5.1. Mechanochemical Reaction

A 1.5 g of the battery constituents (pieces of cathode and anode together with the separator) can be initially ball milled in the 8000M SPEX mill with a halogen-functionalized organic polymer or compound material, such as for example polyvinylidene chloride, for 8 hours in the 50 ml hardened-steel vial with 20 g of steel balls (two large balls weighing 8 g each and four small balls weighing 1 g each). The loading of the sample into the vial and the removal of the product can be performed in air. After the milling, the product is a powder comprising chloride salts of Co and Li.

Step 5.2. Dissolution of the Chlorides

The powder product sample comprising chloride salts of Co and Li obtained from ball milling in step 5.1 can be mixed with deionized water in a beaker (B1) and stirred to dissolve the salts in the water. The obtained mixture has to be filtered in order to separate the insoluble constituents from the solution, which contains Co and Li chlorides.

Step 5.3. Crystallization of Chlorides.

The obtained solution of chlorides can be further evaporated in order to obtain the mixture of LiCl and CoCl₂ powders.

Step 5.4. Separation of Co and Li

Step 5.4.a. Separation by Co Oxalate (CoC₂O₄) Precipitation

In the water solution of two salts, obtained in the Step 5.2, oxalic acid (H₂C₂O₄) can be added. As a result of reaction R4, the highly insoluble in water cobalt oxalate salt CoC₂O₄ can be precipitated and filtered from the solution.

CoCl₂+C₂H₂O₄=CoC₂O₄↓+2HCl (R4)

The cobalt oxalate can be further converted into the cobalt oxide when heated (calcined) in the air atmosphere.

Step 5.4.b. Separation by LiCl Evaporation

Separation of LiCl from CoCl₂ can be also performed using the difference in their melting temperatures (Tₘ(LiCl=605°) C.; Tₘ(CoCl₂)=735° C.). Mixture of two salts can be sealed in quartz ampoule. One end of the ampoule, where all mixture will be placed can be loaded into the furnace, heated to ˜650° C. Another end of the ampoule will be outside the furnace, thus ensuring the gradient of temperature inside the ampoule. The LiCl, which will melt above 605° C. will recrystallize in the colder end of the ampoule, thus separated from the CoCl₂.

Although the present invention has been described with respect to certain illustration embodiments, those skilled in the art will appreciate that the invention is not limited to these embodiments and that changes and modifications can be made thereto within the scope of the invention as set forth in the appended claims.

References which are incorporated herein by reference:
[1] U.S. Department of Energy, 2015 Quadrennial Technology Review, appendix Chapter 6 on Critical Materials (Washington, D.C., U.S. Department of Energy).
[2] S. Castillo, F. Ansart, C. Laberty-Robert, J. Portal, J. Power. Sources, 2002, 112, 247-254.
[3] E. P. Roth, C. J. Orendorff, Electrochem. Soc. Interface, 2012, 45.
[4] D. H. P. Kang, M. J. Chen, O. A. Ogunseitan, Environ. Sci. Technol., 2013, 47 (10), 5495-5503.
[5] L. Gaines, Sustainable Mater. Technol., 2014, 1-2, 2-7
[6] H. Ku, Y. Jung, M. Jo, S. Park, S. Kim, D. Yang, K. Rhee, E.-M. An, J. Sohn, K. Kwon, J. Hazard. Mater., 2016, 313, 138.
[7] L. Li, L. Zhai, X. Zhang, J. Lu, R. Chen, F. Wu, K. Amine, J. Power Sources, 2014, 262, 380.
[8] M. Joulie, R. Laucournet, E. Billy, J. Power Sources, 2014, 247, 551.
[9] X. Chen, Y. Chen, T. Zhou, D. Liu, H. Hu, S. Fan, Waste Management, 2015, 38, 349.
[10] A. A. Nayl, R. A. Elkhashab, S. M. Badawy, M. A. El-Khateeb, Arabian J. Chem., 2017, 10, S3632.
[11] S.-G. Zhu, W.-Z. He, G.-M. Li, X. Zhou, X.-J. Zhang, J.-W. Huang, Trans. Nonferrous Met. Soc. China, 2012, 22, 2274.
[12] D. Mishra, D. Kim, D. E. Ralph, J. G. Aim, Y. H. Rhee, Waste Manage, 2008, 28, 333.
[13] B. P. Xin, D. Zhang, X. Zhang, Y. T. Xia, F. Wu, S. Chen, L. Li, Bioresour. Technol., 2009, 100, 6163.
[14] L. Li, J. Ge, R. Chen, F. Wu, S. Chen, X. Zhang, Waste Manage, 2010, 30, 2615.
[15] D. Cheret, S. Santen, European Patent, 1589121, 2005-10-26.
[16] G-X. Ren, S.-W. Xiao, M.-Q. Xie, B. Pan, J. Chen, F.-G. Wang, X. Xia, Trans. Nonferrous Met. Soc. China, 2017, 27, 450.
[17] J. Heulens, D. Van Horebeek, M. Quix, S. Brouwer, United States Patent Application 20170229744, 2017.

We claim:

1. A method for recycling spent LIB material, comprising subjecting the spent LIB material to mechanochemical processing by mechanical processing the spent LIB material in the presence of a metallic reducing agent to produce a recovered metal or metal alloy product.

2. The method of claim 1 wherein the spent LIB material comprises spent cathode material.

3. The method of claim 1 wherein the spent LIB material also includes spent anode material and/or metallic separator material.

4. The method of claim 1 wherein the recovered product comprises a magnetic metal or metal alloy.

5. The method of claim 4 wherein the magnetic metal or alloy comprises Co metal or Co alloy.

6. The method of claim 5 further including magnetically separating the Co metal or Co alloy from non-magnetic by-products.

7. The method of claim 5 wherein the recovered product includes Li oxide.

8. The method of claim 7 including further treating the Li oxide to recover a water insoluble Li-containing product.

9. The method of claim 1 wherein the reducing agent comprises at least one of Li, Na, K, Mg, Ca, Sr, Ba, Al, Zn, rare earth metal, and mischmetal.

10. The method of claim 1 wherein the mechanical processing includes at least one of milling, grinding, shredding, or extruding of the spent LIB material under inert gas atmosphere or in air without or with liquid assistant agent.

11. The method of claim 1 wherein mechanochemical processing is conducted in the absence of a solvent.

12. The method of claim 1 wherein mechanochemical processing is conducted in the presence of a liquid assistant agent.

13. A method for recycling spent LIB material, comprising subjecting the spent LIB material to mechanochemical processing by mechanical processing the spent LIB material in the presence of an organic chemical compound or a polymer having a functional moiety that reacts with at least one constituent of the LIB material to produce a water-soluble metal salt.

14. The method of claim 13 wherein the functional moiety comprises a halogen.

15. The method of claim 14 wherein the polymer comprises at least one of a polyvinylidene halide, a halogenated polyethylene, a halogenated polystyrene, and halogenated co-polymer.

16. The method of claim 14 wherein the organic chemical compound comprises a halogenated carboxylic acid.

17. The method of claim 13 wherein the metal salt comprises at least one of Co halide and Li halide.

18. The method of claim 17 including further treating the metal salt by aqueous acidic or basic reaction.

19. The method of claim 13 wherein the mechanical processing includes at least one of milling, grinding, shredding, or extruding of the spent LIB material under inert gas atmosphere or in air without or with liquid assistant agent.

20. The method of claim 13 wherein mechanochemical processing is conducted in the absence of a solvent.
